(19) United States
(12) Patent Application Publication
(10) Pub. No.: US 2015/0107703 A1
(43) Pub. Date: Apr. 23, 2015

(54) FLOW CONTROL VALVE

(71) Applicant: AISAN KOGYO KABUSHIKI KAISHA, Obu-shi (JP)

(72) Inventor: Shigeki Yamada, Nagoya-shi (JP)

(21) Appl. No.: 14/468,542

(22) Filed: Aug. 26, 2014

(30) Foreign Application Priority Data
Aug. 7, 2013 (JP) 2013-163927

(51) Int. Cl. F16K 1/52; G01M 3/28

(52) U.S. Cl. CPC F16K 1/52; G01M 3/2876
USPC 137/551

(57) ABSTRACT

A flow control valve has a case defining an inlet and an outlet and a valve body capable of reciprocating in the case. The case has a measuring hole portion therein. The measuring hole portion has a plurality of projections inwardly protruding in the redial direction and a plurality of recesses outwardly depressing in the radial direction such that the projections and the recesses are alternately arranged in the circumferential direction. The valve body has a measurement shaft that has a basal end portion having larger diameter than its tip end portion. The measurement shaft of the valve body is inserted into the measuring hole portion. The measurement shaft is configured to move in the in the reciprocating direction in order to measure the flow rate of fluid flowing from the inlet to the outlet through a space between the measuring hole portion of the case and the measurement shaft.

### CROSS-REFERENCES TO RELATED APPLICATIONS

This application claims priority to Japanese Patent Application Serial Number 2013-163927, filed on Aug. 7, 2013, the contents of which are incorporated herein by reference in their entirety for all purposes.

### STATEMENT REGARDING FEDERALLY SPONSORED RESEARCH OR DEVELOPMENT

Not applicable.

### BACKGROUND OF THE INVENTION

The present application relates to a flow control valve for controlling the flow rate of a fluid.

Japanese Laid-Open Patent Publication No. 2007-182939 discloses a representative example of a PCV (positive crankcase ventilation) valve, which is used as a reduction device for blow-by gas from an internal combustion engine of a vehicle such as automobile.

A conventional example of the PCV valve will be described. FIG. 17 is a cross-sectional view of a PCV valve. As shown in FIG. 17, a PCV valve 100 has a case 104 and a valve body 105, which is housed in the case 104 and is capable of reciprocating therein. The case 104 is formed in a hollow cylinder shape and has an outlet 102 and an inlet 103. A base portion (right end portion in FIG. 17) of the case 104 is configured to be attached to a cylinder head cover (not shown) of an internal combustion engine. The inlet 103 of the case 104 is fluidly communicated with an inner space of the cylinder head cover. The outlet 102 of the case 104 is fluidly communicated with a passage portion downstream of a throttle valve (not shown) in an intake passage of the internal combustion engine.

In the case 104, a measuring hole portion 107 is formed between the outlet 103 and the inlet 102. The valve body 105 has a straight-shaped base shaft 109 and a measurement shaft 110 extending forward from the base shaft 109. The measurement shaft 110 has a front end and a rear end having a larger diameter than the front end. Each of the base shaft 109 and the measurement shaft 110 is shaped to have a circular cross-section. The measurement shaft 110 has a large diameter shaft 110a having the same diameter with the base shaft 109. Between the case 104 and the valve body 105, a valve spring 112 is provided to bias the valve body 105 toward the inlet 103.

When intake negative pressure is generated in the intake passage of the internal combustion engine and when the intake negative pressure is introduced into an inner space of the case 104 via the outlet 102, the valve body 105 is moved toward the outlet 102 against a biasing force of the valve spring 112 due to action of the negative pressure in the PCV valve 100. A position of the measurement shaft 110 is changed in a reciprocation direction (an axial direction) of the valve body 105 in the measuring hole portion 107 such that the amount of blow-by gas flowing from the inlet 103 to the outlet 102 through a gap between the measuring hole portion 107 and the measurement shaft 110 is measured. An outer circumferential surface of the measurement shaft 110 of the valve body 105 has a plurality of (for example, three) straight-shaped guide ribs 114 radially extending toward the base shaft 109 (i.e., in the axial direction of the valve body 105). When the valve body 105 reciprocates, the guide ribs 114 slidingly contact an inwardly facing surface of the measuring hole portion 107 in order to guide the valve body 105 in the axial direction.

In the PCV valve 100, when the valve body 105 is moved to a movement position (shown by a two-dot chain line 105 in FIG. 17) away from an initial position of the valve body 105, which corresponds to a movement position in a condition that the internal combustion engine is in an idle zone and generates large negative pressure, the large diameter shaft 110a of the measurement shaft 110 of the valve body 105 is located at the measuring hole portion 107 of the case 104. In this state, a space between the measuring hole portion 107 and the measurement shaft 110 is small. Thus, moisture in the blow-by gas is likely to accumulate at a minimum gap of the space, and the accumulated moisture is likely to spread into the space in the circumferential direction due to its surface tension. When falling into the sub-zero range, the moisture accumulated in the widespread space freezes, and there is a risk that the measuring hole portion 107 and the measurement shaft 110 are fixed due to such freezing of the moisture. In a state that freezing is intense, because binding force between the measuring hole portion 107 and the measurement shaft 110 is strong, there is a risk that the valve body 105 cannot work normally. Radial outer end surfaces of the guide ribs 114 projecting from the valve body 105 are formed to match with an outer circumferential surface of the large diameter shaft 110a of the measurement shaft 110. Accordingly, in the state that the valve body 105 is in the movement region (shown by the two-dot chain line 105 in FIG. 17) away from the initial position of the valve body 105, the guide ribs 114 do not correspond to or do not substantially correspond to the measuring hole portion 107. Thus, spread of the moisture in the circumferential direction in the space between the measuring hole portion 107 and the measurement shaft 110 can be prevented in each recess between a pair of the guide ribs 114 lying next to each other in the circumferential direction.

### BRIEF SUMMARY OF THE DISCLOSURE

In one aspect of the present disclosure, a flow control valve has a case defining an inlet and an outlet and a valve body capable of reciprocating in the case. The case has a measuring hole portion therein. The measuring hole portion has a plurality of projections inwardly protruding in the redial direction and a plurality of recesses outwardly depressing in the radial direction such that the projections and the recesses are alternately arranged in the circumferential direction. The valve body has a measurement shaft. The measurement shaft has a basal end portion having larger diameter than its tip end portion. The measurement shaft of the valve body is inserted into the measuring hole portion. The measurement shaft is configured to move in the reciprocating direction in order to measure the flow rate of fluid flowing from the inlet to the outlet through a space between the measuring hole portion of the case and the measurement shaft.

In accordance with this aspect, in a condition that the valve body is moved to a movement region away from an initial position of the valve body, the space between the projections of the measuring hole portion and the basal end, i.e., a large diameter shaft of the measurement shaft is small, whereas the space between the recesses of the measuring hole portion and the large diameter shaft of the measurement shaft is large. Thus, radial spread of the moisture form the space between the projections of the measuring hole portion and the large diameter shaft of the measurement shaft can be prevented. Accordingly, when the moisture accumulated in the space between the projections of the measuring hole portion and the large diameter shaft of the measurement shaft is frozen below the freezing point, because such freeze area is small, the binding force between the measuring hole portion and the measurement shaft due to freezing can be decreased. In addition, freeze between the measuring hole portion and the measurement shaft can be removed due to action of the valve body or vibration of the internal combustion engine, etc. So, failure of action of the valve body caused by freeze between the measuring hole portion of the case and the measurement shaft of the valve body can be prevented. Further, because the projections are formed at the measuring hole portion of the case, the projections rarely interferes with handling of components compared with a case that the projections are formed to protrude from the measurement shaft of the valve body.

### BRIEF DESCRIPTION OF THE DRAWINGS

FIG. 1 is a cross-sectional view of a PCV valve according to a first embodiment;

FIG. 2 is a cross-sectional view along a line II-II;

FIG. 3 is a cross-sectional view along a line III-III;

FIG. 4 is a cross-sectional view of the PCV valve in a condition that an internal combustion engine is in an idle zone;

FIG. 5 is a cross-sectional view along a line V-V;

FIG. 6 is a cross-sectional view of a measuring hole portion according to a second embodiment;

FIG. 7 is a cross-sectional view of a measuring hole portion according to a third embodiment;

FIG. 8 is a cross-sectional view of a measuring hole portion according to a fourth embodiment;

FIG. 9 is a cross-sectional view of a measuring hole portion according to a fifth embodiment;

FIG. 10 is a cross-sectional view of a measuring hole portion according to a sixth embodiment;

FIG. 11 is a cross-sectional view of a measuring hole portion according to a seventh embodiment;

FIG. 12 is a cross-sectional view of a measuring hole portion according to an eighth embodiment;

FIG. 13 is a cross-sectional view of a measuring hole portion according to a ninth embodiment;

FIG. 14 is a cross-sectional view of a PCV valve according to a tenth embodiment;

FIG. 15 is a cross-sectional view along XV-XV line;

FIG. 16 is a cross-sectional view of a measuring hole portion according to an eleventh embodiment; and

FIG. 17 is a cross-sectional view of a conventional PCV valve.

### DETAILED DESCRIPTION

Each of the additional features and teachings disclosed above and below may be utilized separately or in conjunction with other features and teachings to provide improved flow control valves. Representative examples, which utilize many of these additional features and teachings both separately and in conjunction with one another, will now be described in detail with reference to the attached drawings. This detailed description is merely intended to teach a person of ordinary skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples. Moreover, various features of the representative examples and the dependent claims may be combined in ways that are not specifically enumerated in order to provide additional useful embodiments of the present teachings.

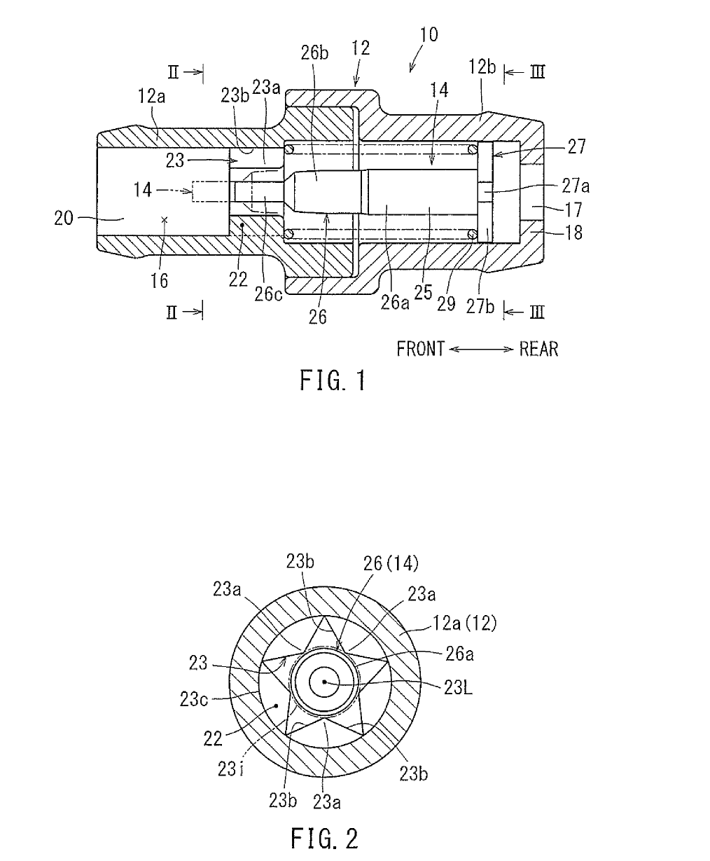

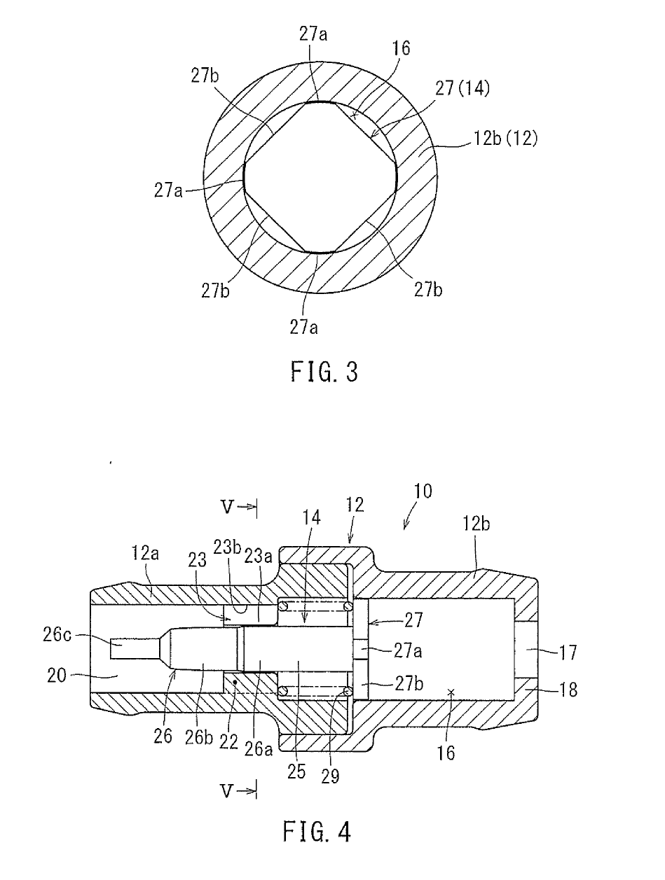

A first embodiment will be described. In this embodiment, a PCV valve is exemplified as flow control valve used for a blow-by gas reduction device for an internal combustion engine. The blow-by gas reduction device of the internal combustion engine is configured to return into the intake passage blow-by gas leaking from a combustion chamber of the internal combustion engine into a crankcase in order to burn the returned blow-by gas in the combustion chamber. The PCV valve is used to control the amount of the blow-by gas introduced into the intake passage from the crankcase of the internal combustion engine. FIG. 1 is a cross-sectional view of the PCV valve. FIG. 2 is a cross-sectional view along a line II-II shown in FIG. 1. FIG. 3 is a cross-sectional view along a line III-III shown in FIG. 1. For convenience of explanation, a left side in FIG. 1 is defined as a front side (tip side) of the PCV valve, and a right side in FIG. 1 is defined as a rear side (base side) of the PCV valve.

As shown in FIG. 1, a PCV valve 10 has a case 12 and a valve body 14. The case 12 is divided into a front case half 12a and a rear case half 12b in a front-rear direction (axial direction). The case halves 12a and 12b are engaged with each other in order to form the case 12 in a hollow cylinder shape. The case halves 12a, 12b are made from, for example, resin material. An inner space of the case 12 is configured as a gas passage 16 extending in the axial direction. The case 12 has an inlet 17 at a rear end (right end in FIG. 1). The rear case half 12b has at its rear end a flange-shaped end wall 18 projecting inwardly in the radial direction such that a hollow space defined by the end wall 18 corresponds to the inlet 17. The case 12 has an outlet 20 at its front end. The rear case half 12b is horizontally attached to, for example, a cylinder head cover (not shown) of the internal combustion engine. The inlet 17 of the case 12 is fluidly communicated with an inner space of the cylinder head cover. The outlet 20 of the case 12 is fluidly communicated with a passage portion downstream of a throttle valve (not shown) in the intake passage of the internal combustion engine.

The front case half 12a has at a middle section in the axial direction a flange-shaped projection wall 22 inwardly protruding in the radial direction. A radially inwardly facing portion of the projection wall 22 is a measuring hole portion 23. The measuring hole portion 23 is formed concentrically with the case 12. Here, the projection wall 22 corresponds to “hole forming member” in this specification. And, a shape of the measuring hole portion 23 will be described later.

The valve body 14 is made from, for example, resin material and is formed in a shaft shape. The valve body 14 is housed in the case 12 and is capable of reciprocating in the front-rear direction (axial direction). The valve body 14 has a base shaft 25 formed in a straight shape, a measurement shaft 26 extending forward from the base shaft 25, and a flange portion 27 outwardly projecting in the radial direction from a rear end (base portion) of the base shaft 25. The measurement shaft 26 has a rear end having a larger diameter than that of its front end. Each of the measurement shaft 26 and the base shaft 25 is formed to have a circular cross-section.

The measurement shaft 26 concentrically has a large diameter shaft 26a, a tapered shaft 26b and a small diameter shaft 26c such that the large diameter shaft 26a, the tapered shaft 26b and the small diameter shaft 26c are sequentially aligned toward the front direction. The large diameter shaft 26a is formed in a straight shape having the same outer diameter with the base shaft 25 and is formed at a base end (rear end) of the measurement shaft 26. The tapered shaft 26b extends forward from the large diameter shaft 26a (leftward in FIG. 1) and is formed in a tapered shape gradually decreasing its outer diameter. The small diameter shaft 26c is formed in a straight shape having the same outer diameter with a small diameter end (front end) of the tapered shaft 26b and extends forward from the front end of the tapered shaft 26b.

The measurement shaft 26 of the valve body 14 is inserted into the measuring hole portion 23 of the case 12 from an inlet 17 side (rear side) toward an outlet 20 side (front side). The flange portion 27 of the valve body 14 is fitted into the case 12 (in detail, the rear case half 12b) such that the valve body 14 can move in the axial direction. As shown in FIG. 3, on a circumferential surface of the flange portion 27, for example, four arc-shaped sliding surfaces 27a and four plane cut-off surfaces 27b are alternately aligned in the circumferential direction. Each of the sliding surfaces 27a is configured to slidably contact an inwardly facing surface of the rear case half 12b, that is, an interior wall of the gas passage 16. The blow-by gas can flow through spaces between the interior wall of the gas passage 16 and the cut-off surfaces 27b.

A valve spring 29 composed of a compression coil spring is provided between the case 12 and the valve body 14 in order to bias the valve body 14 toward the inlet 17 side (rear side) (see FIG. 1). The valve spring 29 is fitted with the valve body 14 and is set between the projection wall 22 and the flange portion 27 of the valve body 14.

In the PCV valve 10, in a condition where the internal combustion engine is stopped, because negative pressure is not generated in the intake passage and the valve body 14 is biased due to elastic force of the valve spring 29, the flange portion 27 of the valve body 14 is located near the end wall 18 of the of the rear case half 12b (see the valve body 14 shown by a solid line in FIG. 1). On the other hand, when the internal combustion engine is started, negative pressure generated in the intake passage is applied into the case 12 via the outlet 20, so that the valve body 14 is moved toward the outlet 20 against the biasing force of the valve spring 29 due to action of the negative pressure.

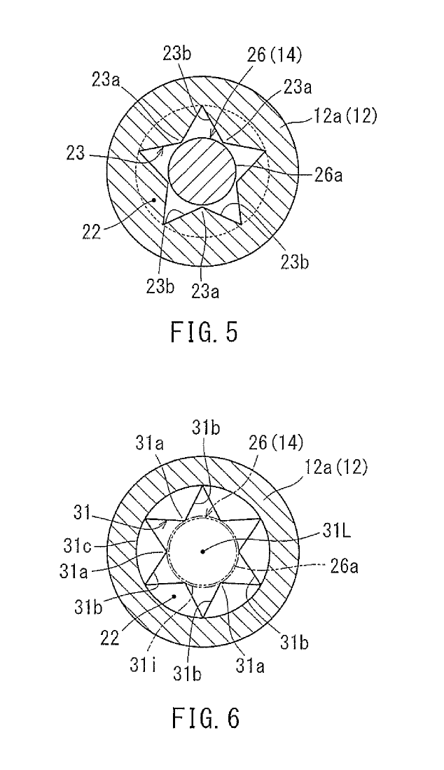

In a condition that the internal combustion engine works in a low load operation, i.e., the internal combustion engine is in an idle zone, because an opening ratio of the throttle valve is small, negative pressure generated in the intake passage is high. Thus, the valve body 14 is moved for a long distance toward the outlet 20 side (front side) due to the negative pressure. In this state, the large diameter shaft 26a of the measurement shaft 26 of the valve body 14 is located in the measuring hole portion 23 as shown in FIG. 4. Here, FIG. 4 is a cross-sectional view of the PCV valve in the condition that the internal combustion engine is in the idle zone. FIG. 5 is a cross-sectional view along V-V line shown in FIG. 4. Accordingly, because a space between the measuring hole portion 23 and the large diameter shaft 26a of the measurement shaft 26, i.e., a cross-sectional area of a passage for the blow-by gas is small, the amount of the blow-by gas flowing through the PCV valve 10 is small.

Whereas, in a condition that the internal combustion engine works in a middle load operation, i.e., the internal combustion engine is in a partial zone, because the opening ratio of the throttle valve is large, the negative pressure generated in the intake passage is small. Thus, the valve body 14 is biased due to elastic force of the valve spring 29 and is moved toward the inlet 17 side (rear side). Accordingly, the tapered shaft 26b of the measurement shaft 26 of the valve body 14 is located in the measuring hole portion 23 (see the valve body 14 shown by a two-dot chain line in FIG. 1). As the valve body 14 moves in this way, the space between the tapered shaft 26b of the valve body 14 and the measuring hole portion 23, that is, the cross-sectional area of the passage for the blow-by gas gradually increases. So, the flow rate of the blow-by gas flowing through the PCV valve 10 in the condition that the internal combustion engine is in the middle load operation is larger than that in the internal combustion engine is in the low load operation.

In a condition that the internal combustion engine works in a high load operation, i.e., the internal combustion engine is in a WOT (Wide Open Throttle) zone, because the valve body 14 is biased due to elastic force of the valve spring 29 and is further moved toward the inlet 17 side (rear side), the sectional area of the passage for the blow-by gas, which is formed between the small diameter shaft 26c of the valve body 14 and the measuring hole portion 23, is maximum (see the valve body 14 shown by a solid line in FIG. 1). Thus, the flow rate of the blow-by gas is largest. As described above, the position of the measurement shaft 26 is changed in the measuring hole portion 23 of the case 12 in a direction where the valve body 14 reciprocates in order to measure (meter) the flow rate of the blow-by gas flowing from the inlet 17 to the outlet 20 through the space between the measuring hole portion 23 and the measurement shaft 26.

Next, a shape of the opening of the measuring hole portion 23 of the case 12 will be described. As shown in FIG. 2, the measuring hole portion 23 is formed to have an opening formed in a pentagonal structure, in detail regular pentagonal shape, as viewed along the axis of the measuring hole portion 23. Thus, the measuring hole portion 23 has five triangular projections 23a inwardly protruding in the radial direction and five triangular groove-shaped recesses 23b outwardly depressing in the radial direction such that the five projections 23a and the five recesses 23b are alternately arranged in the circumferential direction. The measuring hole portion 23 is formed to have the opening having a circumscribed circle 23c and an inscribed circle 23i, which are concentrically formed with an axis 23L of the measuring hole portion 23. In this embodiment, the circumscribed circle 23c is positioned on an inwardly facing surface of the front case half 12a on the outlet 20 side, i.e., the interior wall of the gas passage 16 (see FIG. 1). The opening of the measuring hole portion 23 is continuously formed over the length of the measuring hole portion 23 in the axial direction.

According to the above-described PCV valve 10 (FIG. 1), with respect to the space between the measuring hole portion 23 of the case 12 and the large diameter shaft 26a of the measurement shaft 26 of the valve body 14 at the movement region away from the initial position of the valve body 14 for a long distance, i.e., the movement region corresponding to the state where the internal combustion engine is in the idle zone (see FIG. 4), each of the projections 23a of the measuring hole portion 23 and the large diameter shaft 26a of the measurement shaft 26 define a narrow space therebetween, whereas each of the recesses 23b of the measuring hole portion 23 and the large diameter shaft 26a of the measurement shaft 26 can define a broader space therebetween (FIG. 5). Due to this configuration, it is able to prevent moisture from spreading in the circumferential direction from the space between each of the projections 23a of the measuring hole portion 23 and the large diameter shaft 26a of the measurement shaft 26. Thus, even if the moisture accumulated in the space between each of the projections 23a of the measuring hole portion 23 and the large diameter shaft 26a of the measurement shaft 26 is frozen below the freezing point, such freeze area is small and thus binding force caused by freezing between the measuring hole portion 23 and the measurement shaft 26 can be decreased. Accordingly, freeze fixation between the measuring hole portion 23 and the measurement shaft 26 can be easily released by action of the valve body 14 or vibration of the internal combustion engine, etc. In this way, failure of action of the valve body 14 caused by freeze between the measuring hole portion 23 of the case 12 and the measurement shaft 26 of the valve body 14 can be prevented. In addition, because the projections 23a are formed at the measuring hole portion 23 of the case 12, the projections 23a rarely interferes with handling of components compared with a case that projections are formed on the measurement shaft 26 of the valve body 14.

The measuring hole portion 23 has the opening having the circumscribed circle 23c arranged concentrically with the axis 23L of the measuring hole portion 23 (FIG. 2). Thus, the measuring hole portion 23 can be positioned in the circumscribed circle 23c arranged concentrically with the axis 23L of the measuring hole portion 23.

The measuring hole portion 23 has the opening having the inscribed circle 23i arranged concentrically with the axis 23L of the measuring hole portion 23 (FIG. 2). At the movement region away from the initial position of the valve body 14 for a long distance (FIG. 4), the projections 23a of the measuring hole portion 23 can be located adjacent to or contact with the large diameter shaft 26a of the measurement shaft 26. Accordingly, each of the projections 23a of the measuring hole portion 23 can be used as guide member for guiding the valve body 14 in the axial direction.

Each of the five projections 23a of the measuring hole portion 23 is formed in a triangular shape viewed along the axial direction of the measuring hole portion 23 (FIG. 2). Thus, each of the projections 23a formed in the triangular shape viewed along the axial direction can be located adjacent to or contact with the large diameter shaft 26a of the measurement shaft 26 in a point contact state. Accordingly, a freeze area between the measuring hole portion 23 and the measurement shaft 26 can be decreased.

The opening of the measuring hole portion 23 is formed in a polygonal shape viewed along the axial direction of the measuring hole portion 23 (FIG. 2). Thus, the recesses 23b are respectively positioned at interior angles of the polygonal shape of the opening viewed from the axial direction of the measuring hole portion 23, and each of the projections 23a is positioned between a pair of the recesses 23b adjacent to each other.

The polygonal shape of the opening of the measuring hole portion 23 is star-shaped polygonal structure (FIG. 2). Thus, each of the peaked projections can be located between a pair of the recesses 23b adjacent to each other.

A second embodiment will be described. Because following embodiments are identical to the first embodiment each having some modifications, such modifications will be described and the same configurations will not be described. FIG. 6 is a cross-sectional view showing the measuring hole portion 31 in the second embodiment. As shown in FIG. 6, the measuring hole portion 31 in the second embodiment has an opening formed in a star-shaped hexagon, in detail star-shaped regular hexagon (the compound of two equilateral triangles) viewed along the axis of the measuring hole portion 31 instead of the measuring hole portion 23 in the first embodiment. The measuring hole portion 31 has six triangular projections 31 a inwardly projecting in the radial direction and six triangular groove-shaped recesses 31b outwardly depressing in the radial direction such that the six projections 31a and the six recesses 31a are alternately arranged in the circumferential direction. The measuring hole portion 31 has the opening having the circumscribed circle 31c and the inscribed circle 31i, which are arranged concentrically with the axis 31L of the measuring hole portion 31. Here, the opening can be formed in a star-shaped regular heptagon, a star-shaped regular octagon, a star-shaped regular nonagon or the like, and can be formed in a star-shaped polygon instead of such star-shaped regular polygon.

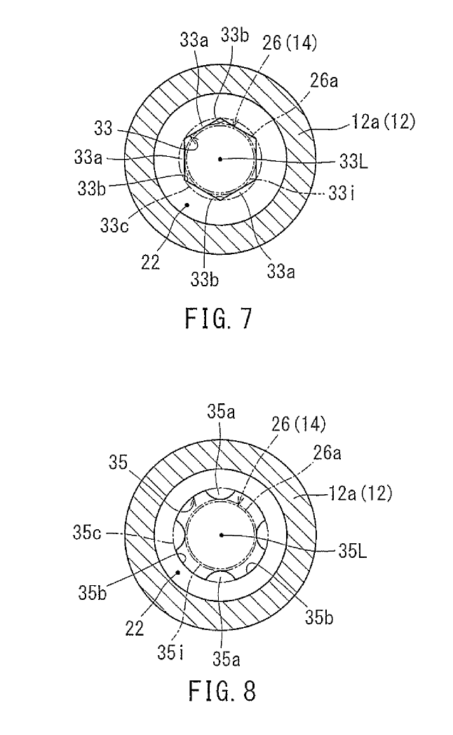

A third embodiment will be described. FIG. 7 is a cross-sectional view showing the measuring hole portion 33 in the third embodiment. As shown in FIG. 7, the measuring hole portion 33 in the third embodiment has an opening formed in a polygonal shape, in detail a regular hexagonal shape viewed along the axis of the measuring hole portion 33 instead of the measuring hole portion 23 in the first embodiment. Thus, recesses 33b are respectively positioned at interior angles of the polygonal shape of the opening viewed along the axial direction of the measuring hole portion 33, and each of projections 33a is positioned between a pair of the recesses 33b adjacent to each other. The measuring hole portion 33 has the opening having circumscribed circle 33c and the inscribed circle 33i, which are arranged concentrically with the axis 33L of the measuring hole portion 33. Here, the opening can be formed in a regular triangle, a regular tetragon, regular pentagon or the like, and can be formed in a polygon instead of such regular polygon.

A fourth embodiment will be described. FIG. 8 is a cross-sectional view of the measuring hole portion 35 in the fourth embodiment. As shown in FIG. 8 viewed along the axial direction of the measuring hole portion 35, the measuring hole portion 35 has four projections 35a inwardly projecting in the radial direction and four recesses 35b outwardly depressing in the radial direction such that the projections 35a and the recesses 35b are alternately arranged in the circumferential direction. Each of the projections 35a is formed in an arc-shape viewed along the axial direction of the measuring hole portion 35. The projections 35a are positioned at regular intervals in the circumferential direction. The measuring hole portion 35 has an opening having the circumscribed circle 35c and the inscribed circle 35i, which are arranged concentrically with the axis 35L of the measuring hole portion 35. A bottom surface of each recesses 35b is formed in an arc-like shape corresponding to the circumscribed circle 35c. According to this embodiment, each of the four projections 35a of the measuring hole portion 35 is formed in the arc-shape viewed along the axial direction of the measuring hole portion 35. Thus, the projections 35a each formed in the arc-shape can be positioned adjacent to or contacted with the large diameter shaft 26a of the measurement shaft 26 in a point contact state. Accordingly, a freeze area between the measuring hole portion 35 and the measurement shaft 26 can be decreased.

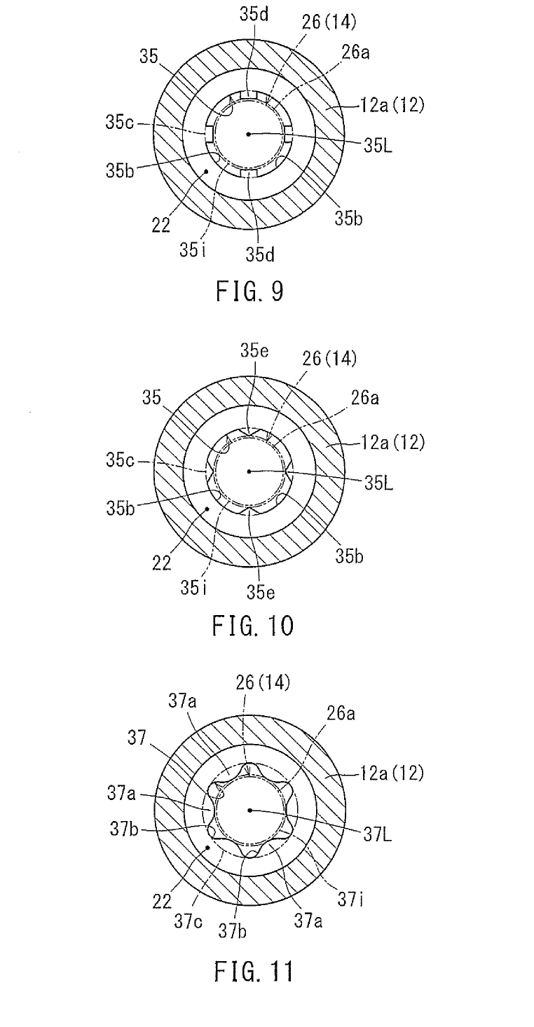

A fifth embodiment will be described. FIG. 9 is a cross-sectional view of the measuring hole portion 35 in the fifth embodiment. As shown in FIG. 9, each of the projections 35d of the measurement shaft 35 is formed in a polygonal shape, in detail, in a square shape viewed along the axial direction of the measurement shaft 35. In this embodiment, each of the projections 35d of the measurement shaft 35 can be positioned adjacent to or contacted with the large diameter shaft 26a of the measurement shaft 26. Accordingly, a freeze area between the measuring hole portion 35 and the measurement shaft 26 can be decreased.

A sixth embodiment will be described. FIG. 10 is a cross-sectional view of the measuring hole portion 35 in the sixth embodiment. As shown in FIG. 10, each of the projections 35e of the measurement shaft 35 is formed in a polygonal shape, in detail, in a triangular shape viewed along the axial direction of the measurement shaft 35. In this embodiment, each of the projections 35e can be positioned adjacent to or contacted with the large diameter shaft 26a of the measurement shaft 26 in a point contact state. Accordingly, a freeze area between the measuring hole portion 35 and the measurement shaft 26 can be decreased. Here, one to three of the four projections 35a, 35d or 35e in each of the fourth, fifth and sixth embodiments can be modified to identical to the shape of the projection in the other embodiment or can be formed in other shape.

A seventh embodiment will be described. FIG. 11 is a cross-sectional view of the measuring hole portion 37 in the seventh embodiment. The measuring hole portion 37 has six projections 37a inwardly projecting in the radial direction and six recesses 37b outwardly depressing in the radial direction viewed along the axial direction of the measuring hole portion 37 such that the six projections 37a and the six recesses 37b are alternately arranged in the circumferential direction. Each of the six projections 37a is formed in an arc-shape viewed along the axial direction of the measuring hole portion 37. Each of the recesses 37b is formed in an arc-shape viewed along the axial direction of the measuring hole portion 37. The six projections 37a and the six recesses 37b are located at regular intervals in the circumferential direction. The measuring hole portion 37 has an opening having the circumscribed circle 37L and the inscribed circle 37i, which are arranged concentrically with the axis 37L of the measuring hole portion 37. In this embodiment, each of the six projections 37a of the measuring hole portion 37 is formed in the arc-shape viewed along the axial direction of the measuring hole portion 37. Thus, each of the projections 37a formed in the arc-shape viewed along the axial direction of the measuring hole portion 37 can be positioned adjacent to or contacted with the large diameter shaft 26a of the measurement shaft 26 in a point contact state. Accordingly, a freeze area between the measuring hole portion 37 and the measurement shaft 26 can be decreased.

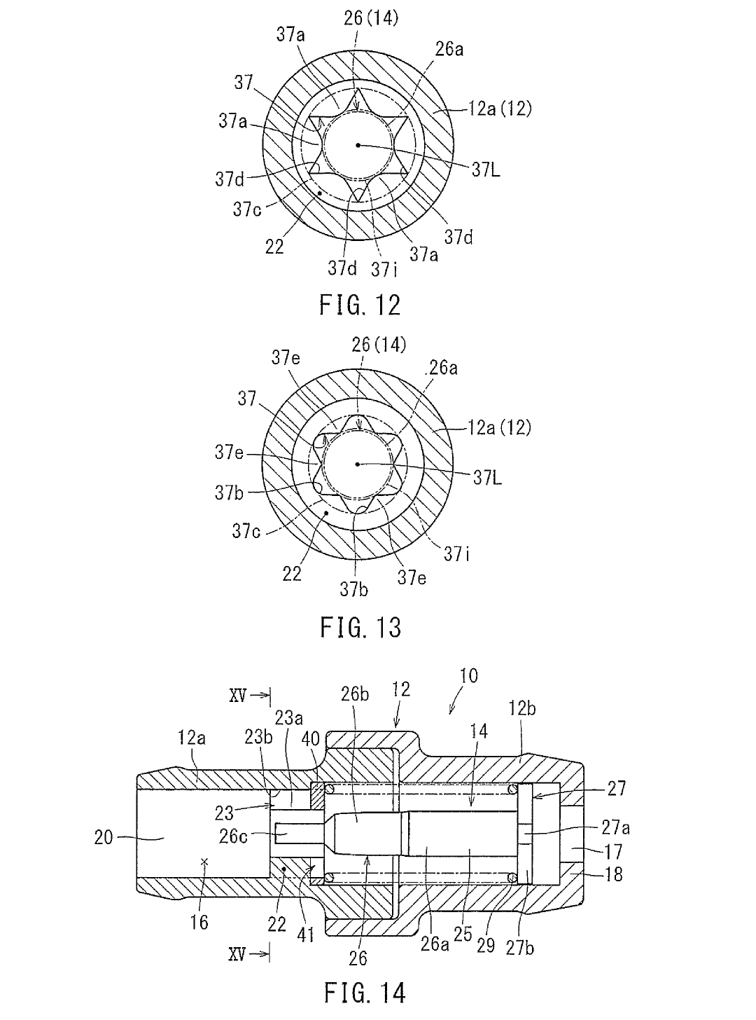

An eighth embodiment will be described. FIG. 12 is a cross-sectional view of the measuring hole portion 37 in the eighth embodiment. As shown in FIG. 12, each of the recesses 37d is shaped to have an included angle, which is formed by a pair of the adjacent projections 37a.

A ninth embodiment will be described. FIG. 13 is a cross-sectional view of the measuring hole portion 37 in the ninth embodiment. As shown in FIG. 13, each of the projections 37e is shaped to have an included angle, which is formed by a pair of the adjacent recesses 37b. In this embodiment, each of the projections 37e of the measuring hole portion 37 is formed in a triangular shape viewed along the axial direction of the measuring hole portion 37. Thus, each of the projections 37e formed in the triangular shape viewed along the axial direction of the measuring hole portion 37 can be positioned adjacent to or contacted with the large diameter shaft 26a of the measurement shaft 26 in a point contact state. Accordingly, a freeze area between the measuring hole portion 37 and the measurement shaft 26 can be decreased.

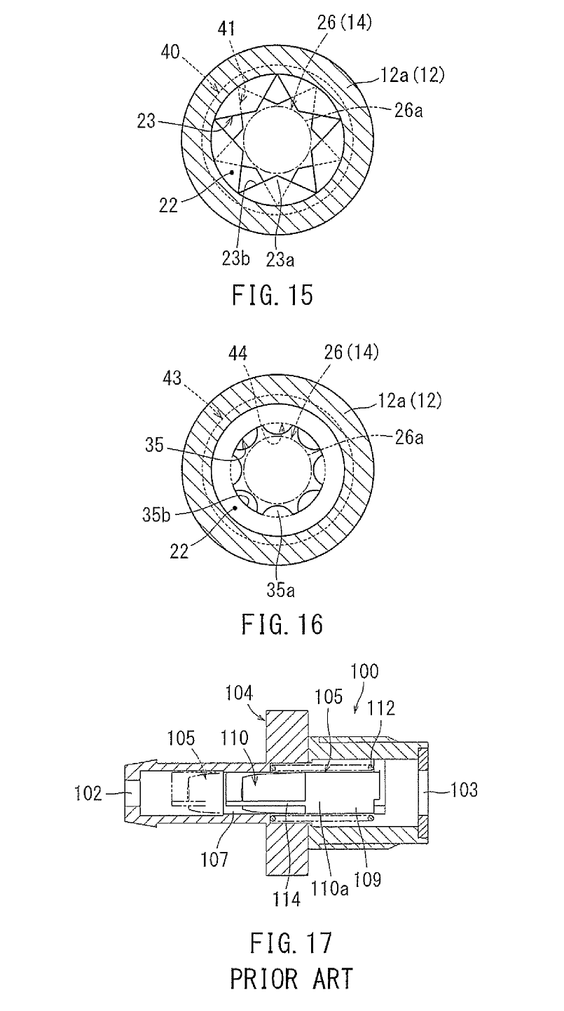

A tenth embodiment will be described. FIG. 14 is a cross-sectional view of a PCV valve. FIG. 15 is a cross-sectional view along a line XV-XV shown in FIG. 14. As shown in FIGS. 14 and 15, in this embodiment, a control plate 40 formed in an annular plate is concentrically located in the front case half 12a of the case 12 of the first embodiment such that the control plate 40 overlaps with a rear section of the projection wall 22. The control plate 40 is fitted to be capable of rotating around the axis relative to the front case half 12a. The control plate 40 has a measuring hole portion 41 formed in the same shape as the measuring hole portion 23 of the projection wall 22 (FIG. 15). Here, the control plate 40 corresponds to “hole forming member” in this specification.

In this embodiment, the control plate 40 can be rotated relative to the front case half 12a in order to adjust an opening space defined by the measuring hole portions 37 and 41, i.e., the degree of overlapping between the measuring hole portions 37 and 41. The control plate 40 is rotatably provided relative to the front case half 12a of the case 12 such that a rotation stopper can stop rotation of the control plate 40 relative to the case half 12a after adjustment of the opening space. Thus, unnecessary rotation of the control plate 40 after adjustment can be prevented. Here, the rotation stopper may be composed of swaging, adhesion, engagement or the like, and, the rotation stopper may include a fixing means for fixing the control plate 40 on the case half 12a. The number of the control plate 40 can be increased as necessary. In addition, the measuring hole portion 41 can be formed by one or more control plates 40 while omitting the measuring hole portion 23 of the projection wall 22 of the front case half 12a.

An eleventh embodiment will be described. FIG. 16 is a cross-sectional view of the measuring hole portion 35 in the eleventh embodiment. As shown in FIG. 16, in this embodiment, the measuring hole portion 35 according to the fourth embodiment (FIG. 8) is formed instead of the measuring hole portion 23 of the projection wall 22 of the front case half 12a according to the tenth embodiment (FIG. 15). In addition, the control plate 43 having the measuring hole portion 44 formed in the same shape with the measuring hole portion 35 is provided instead of the control plate 40 of the tenth embodiment (FIG. 15). Here, the control plate 43 can be replaced with the control plate 40 of the tenth embodiment.

This disclosure is not limited to the above-described embodiments and can be modified without departing from the scope of the principles disclosed herein. For example, this disclosure can be applied to other flow valves for controlling the amount of fluid instead of the PCV valve 10. In the embodiments, the case 12 of the PCV valve 10 is horizontally attached to the cylinder head cover of the internal combustion engine, however the case 12 can be attached to it in the other way. For example, the case 12 can be vertically or obliquely attached to a component such as the cylinder head cover of the internal combustion engine.

1. A flow control valve comprising:
a case defining an inlet and an outlet and having a measuring hole portion therein, the measuring hole portion having a plurality of projections inwardly projecting in the radial direction and a plurality of recesses outwardly depressing in the radial direction such that the projections and the recesses are alternately arranged in a circumferential direction;
a valve body being capable of reciprocating in the case and having a measurement shaft, the measurement shaft having a tip end portion and a basal end portion having a larger diameter than the tip end portion;
wherein the measurement shaft of the valve body is inserted into the measuring hole portion; and
wherein the measurement shaft is moved in the reciprocating direction in order to measure the flow rate of fluid flowing from the inlet to the outlet through a space between the measuring hole portion of the case and the measurement shaft.

2. The flow control valve according to claim 1, wherein the measuring hole portion defines an opening having a circumscribed circle concentric with an axis of the measuring hole portion.

3. The flow control valve according to claim 1, wherein the measuring hole portion defines an opening having an inscribed circle concentric with an axis of the measuring hole portion.

4. The flow control valve according to claim 3, wherein at least one of the projections of the measuring hole portion is formed in an arc-shape viewed along the axis of the measuring hole portion.

5. The flow control valve according to claim 3, wherein at least one of the projections of the measuring hole portion is formed in a polygonal shape viewed along the axis of the measuring hole portion.

6. The flow control valve according to claim 1, the projections and the recesses of the measuring hole portion form a continuous smooth wavelike shape extending in the circumferential direction viewed along the axis of the measuring hole portion.

7. The flow control valve according to claim 1, wherein each of the projections is formed in an arc-shape and each of the recesses is formed to have an included angle formed by a pair of the adjacent projections.

8. The flow control valve according to claim 1, wherein each of the recesses is formed in an arc-shape and each of the projections is formed to have an included angle formed by a pair of the adjacent recesses.

9. The flow control valve according to claim 1, wherein the measuring hole portion defines an opening formed in a polygonal shape viewed along an axis of the measuring hole portion.

10. The flow control valve according to claim 9, the opening of the measuring hole portion is formed in a star-shaped polygonal.

11. The flow control valve according to claim 1, further comprising
a plurality of hole forming members each having the measuring hole portion and aligned in the axial direction, the hole forming members concentrically arranged and provided rotatably around the axis relative to each other, the hole forming members configured to be rotated relative to each other in order to adjust an opening space of the measuring hole portions, the hole forming members each provided to rotate relative to the case; and
a rotation stopper configured to prevent the hole forming members from rotating relative to the case after adjustment of the opening space of the measuring hole portions.
